(19) United States
(12) Patent Application Publication
(10) Pub. No.: US 2020/0039894 A1
(43) Pub. Date: Feb. 6, 2020

(54) NUTRIENT DELIVERY USING HUMIC SUBSTANCE

(71) Applicant: Calvin Van Dyke, Orem, UT (US)

(72) Inventor: Calvin Van Dyke, Orem, UT (US)

(21) Appl. No.: 16/532,046

(22) Filed: Aug. 5, 2019

Related U.S. Application Data
(60) Provisional application No. 62/715,144, filed on Aug. 6, 2018.

(51) Int. Cl. C05F 11/04; A01G 24/22

(52) U.S. Cl. CPC C05F 11/04; A01G 24/22

(57) ABSTRACT

A method for improving nutrient density in crops. The crops may be fed to animals to improve health of the animals and/or to improve bioavailability of such nutrients in animals. The method may include providing a humic substance from an organic material, combining the humic substance with at least one nutrient, and growing crops using the combination of humic substance and at least one nutrient. The method may further include feeding the crops to animals. The combination of humic substance and at least one nutrient may be mixed before growing the crops. The at least one nutrient may include copper, magnesium, manganese, cobalt, zinc, and/or phosphate, among others.

### CROSS-REFERENCE TO RELATED APPLICATIONS

This application claims priority to U.S. provisional patent application Ser. No. 62/715,144, filed on Aug. 6, 2018, the entire contents of which are incorporated herein by reference in their entirety.

### FIELD

The present disclosure relates to improving nutrient density in plants, and more particularly to nutrient uptake for plants and animal feed.

### BACKGROUND

Fulvic acid is a naturally-occurring organic product derived from humus, the organic material in soils produced by the decomposition of organic matter. In addition to fulvic acid, humus also contains humic acid and humin. These humic substances are active components in soil and provide numerous benefits for plants. Fulvic acid is the most plant-active of the humic substances. It is a plant growth stimulator that increases plant metabolism, nutrient intake, and improves root development.

Humic substance, including fulvic acid and humic acid, are largely found in pre-historic deposits of lignite, a soft, brownish coal that has developed from peat through bacterial action over millions of years. Smaller quantities are also found naturally in soil. Thus, while humic substances are naturally-occurring, extracting them from natural sources has proved to be complex and problematic. This is particularly true for extraction of fulvic acid from natural sources. For example, most traditional methods of extraction of fulvic acid in commercial quantities generally require extraction from leonardite, lignite, or coal. Other known techniques involve extraction of humic substance from humic acid bearing mineral ores. These methods generally require the use of acids and bases to leech out the desired components, and often involve many complex processes. Further, humic substance extracted from sources such as leonardite are generally acidic, which limits the ability of the resultant humic substance to chelate various compounds.

### SUMMARY

In various embodiments, the present disclosure provides a method for improving nutrient density in plants. The method disclosed herein generally include improving nutrient uptake and/or bioavailability of nutrients for digestion/use by humans and/or animals consuming the crops. Accordingly, the method may include providing a humic substance from an organic material, combining the humic substance with at least one nutrient, and growing crops using a combination of the humic substance and the at least one nutrient. The method may further include feeding the crops to animals. Combining the humic substance with at least one nutrient may be performed before feeding the crops to animals. The at least one nutrient may include copper, magnesium, manganese, cobalt, zinc, and/or phosphate, among others.

In various embodiments, combining the humic substance with the at least one nutrient is performed during growing the crops such that a combination of the humic substance and the at least one nutrient is provided to the crops during growth. In various embodiments, combining the humic substance with the at least one nutrient comprises providing a static irrigation environment comprising the combination. In various embodiments, growing the crops using the humic substance is performed in a soil-less environment. For example, growing the crops may include utilizing a hydroponic process or an aeroponic process. The organic material may include a substrate within which mushrooms are grown. For example, the substrate may include at least one of wood chips and straw.

In various embodiments, the method further comprises composting the organic material to convert it to organic compost material. That is, composting the organic material to convert it to organic compost material comprises at least one of microbial composting and microbial metabolism of the organic material. The organic material may include at least one of human biosludge, human waste, animal waste, animal carcasses, food, cellulosic materials, lignin, plant matter, wood chips, straw, peat, cardboard, paper, coffee grounds, coir, cocoa shell, garden waste, leaves, grass, seaweed, manure, mushrooms, tree bark, gypsum, hemp fibre, and eggshells, among others. In various embodiments, the organic material comprises about 90% cellulose.

In various embodiments, providing the humic substance comprises introducing a liquid to the organic material and collecting a liquid effluent, wherein the liquid effluent comprises the humic substance. Introducing the liquid to the organic material may include at least one heating step to facilitate extraction of the humic substance.

The forgoing features and elements may be combined in various combinations without exclusivity, unless otherwise expressly indicated herein. These features and elements, as well as the operation of the disclosed embodiments, will become more apparent in light of the following description and accompanying drawings.

### BRIEF DESCRIPTION OF THE DRAWINGS

FIG. 1 is a schematic diagram of a system for producing a liquid effluent comprising humic substance, in accordance with various embodiments;

FIG. 2 is a schematic diagram of a system for delivering nutrients to a crop using humic substance, in accordance with various embodiments;

FIG. 3 is a schematic flow chart diagram of a method for delivering nutrients to animals via crops grown with humic substance, in accordance with various embodiments; and

FIG. 4 is a schematic flow chart diagram of a method for delivering nutrients to animals via crops grown with humic substance, in accordance with various embodiments.

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

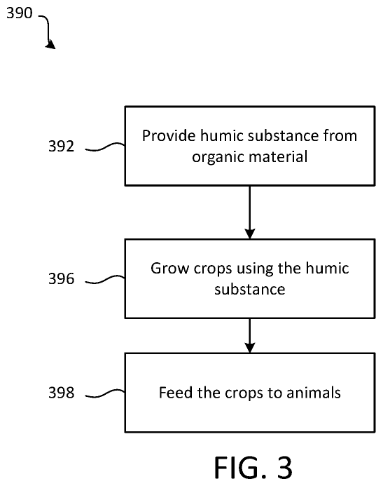

Disclosed herein, according to various embodiments and with reference to FIGS. 2 and 3, is a system and method for improving nutrient density in crops. For example, the system and methods described herein may be used to increase nutrient delivery to animals via animal feed. That is, the system(s) and method(s) disclosed herein generally utilize humic substance, such as fulvic acid and/or humic acid, to increase the nutrient density of plants, which may be ingested by humans and/or animals. While numerous details are included herein pertaining to animal feed, the scope of the disclosure is not limited to growing crops for feeding animals, but may also be applied to crops destined for human consumption. In various embodiments, for example, humic substance extracted from organic material (as opposed to being extracted from leonardite, lignite, coal, or other such sources) are combined with specific nutrients, compounds, and/or elements, and this combination of humic substance and nutrients is used to grow crops. Crops grown with humic substance and additional nutrients, as described in greater detail below, are in turn fed to animals/livestock.

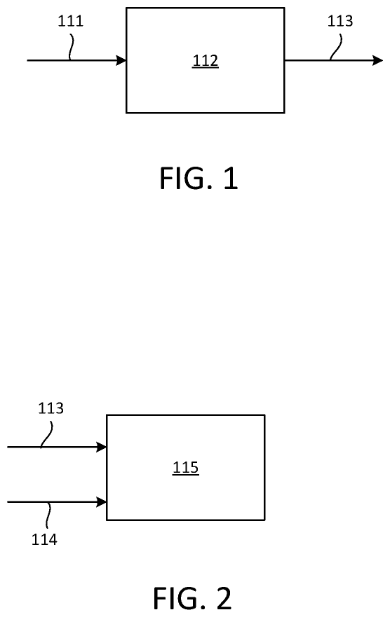

Before describing further details of the systems and methods for improving nutrient density in plants (for example, for delivery to animals via animal feed), it may be beneficial to describe the method(s) and system(s) for producing/providing the humic substance, according to various embodiments. As shown in FIG. 1, a liquid 111 may be first combined with an organic material 112. After the liquid 111 has been combined with the organic material 112, the liquid component of the organic mixture is then extracted from the organic material 112, according to various embodiments. The resulting aqueous liquid effluent 113 contains, among other components, humic substance such as fulvic acid and humic acid. The resulting liquid effluent containing humic substance may have a substantially neutral pH, which may facilitate the ability of the humic substance to chelate nutrients, as described in greater detail below.

The organic material 112 generally includes organic matter and/or organic compost material. The organic material 112 may also include other components, such as water, liquids, and/or additives. The organic material 112 may include substrates within which plants or fungi are grown. For example, in various embodiments the organic material 112 is a medium in which mushrooms are grown, and the organic material 112 may comprise wood chips and/or straw. In various embodiments, the organic material 112 also includes organic compost material, which is defined herein as any product of microbial composting or microbial metabolism of organic matter (both generally referred to herein as “composting”). Such composting occurs when organic matter decays and decomposes, whether naturally or assisted with chemical or microbial additives, into organic compost material. Thus, organic matter is a precursor to organic compost material, according to various embodiments.

In various embodiments, the organic material 112 is organic compost material. Various organic substances may be a suitable source of organic matter to generate the organic compost material. Examples of suitable organic matter for composting include, but are not limited to, human biosludge, human waste, animal waste, animal carcasses, tires, food, cellulosic materials, lignin, construction and demolition materials, plant matter, wood chips, straw, peat, cardboard, paper, coffee grounds, coir, cocoa shell, garden waste, leaves, grass, seaweed, manure, mushrooms, tree bark, gypsum, hemp fibre, eggshells, and the like. In one aspect of the novel system and method, the organic matter contains up to about 90% cellulose, such as grass, algae, cotton, wood pulp, wood chips, paper, cardboard, straw, and the like. One of the benefits of using cellulosic organic matter as a source material for production of humic substance instead of lignite is that the cellulose increases the quantity and production time of humic substance, and is a precursor to and preliminary component of fulvic acid.

The liquid 111 combined with the organic material 112 can be any type of liquid in which fulvic acid can dissolve. In one embodiment, the liquid 111 is water, which dissolves fulvic acid and also provides moisture to the organic material 112 necessary for any microbes in the organic material 112 to carry out the composting process. However, the liquid 111 may be any liquid or solution capable of dissolving fulvic acid. In one aspect, the liquid 111 combined with the organic material 112 is ionic water, which also aids in stabilizing and killing harmful pathogens in the organic material 112. In one embodiment, the water 111 is substantially neutral, non-processed, non-treated water. For example, the water 111 may be process water from an irrigation source or the like.

In various embodiments, the method of producing the liquid effluent 113 containing humic substance includes one or more heating steps that facilitate extraction of the humic substance from the organic material 112. Also, the method may include combining the organic material 112 with plants or fungus. For example, mushrooms have a specific need for organic material, such as organic compost material, because mushrooms (fungi in general) do not carry out the process of photosynthesis and thus all of their nutrients, energy, and food must be supplied to them via the soil they are growing in. Thus, the plants or fungus may be mixed with the organic material 112 (which may not be composted, or which may be composted) and/or one or more heating steps may be performed, either while the plant/fungus is still growing or after harvesting the plant/fungus, to further facilitate collection of humic substance in the effluent 113.

In various embodiments, and with renewed reference to FIGS. 2 and 3, the humic substance in the effluent 113 chelate the additional nutrients 114, thereby facilitating uptake/absorption of the nutrients into the crop 115, thereby increasing the nutrient density of the crop 115 and thus improving the delivery of nutrients to animals that feed on the crop 115. In various embodiments, the humic substance not only facilitates nutrient uptake by the crop, but the humic substance itself may provide various benefits to the animals. For example, humic substance may improve the natural biological activity in the gut of animals, and/or may also facilitate digestion of the crop by the animals, further improving overall nutrient delivery to the animals. In various embodiments, improving the nutrient density of crops that are used for animal feed is more efficient and effective than delivering the same nutrients to the animals directly (e.g., the bioavailability of the nutrients may be increased when delivered to animals indirectly via the crops/feed instead of directly to the animals). In various embodiments, improving the nutrient density of crops that are used for animal feed in the manners described herein enables an increased amount of dry fodder to be used in animal feed rations. That is, in order to optimize performance of the digestive system of animals, such as dairy and beef cows, there often has to be a certain minimum ratio of dry matter (“roughage”) to moisture, and thus the method(s) described herein enables nutrients to be incorporated into the dry matter and thus may improve the dry matter to moisture ratio.

Accordingly, the present disclosure generally provides a method 390, according to various embodiments and with reference to FIG. 3, for improving animal health. The method 390 includes providing humic substance(s) from organic material at step 392, growing crops using the humic substance at step 396, and feeding the crops to animals at step 398. Step 392 may include the details described above with reference to FIG. 1. In various embodiments, as described above, the liquid effluent containing the humic substance may have a substantially neutral pH, which may be substantially different than humic substance obtained from coal or other such sources, as such substances often have an acidic pH (e.g., 1.5 pH). In various embodiments, the humic substance itself may be absorbed into the crop and may improve overall digestion function (e.g., may increase digestive bacteria) of the animal that eats the crop. That is, step 396 may be performed with or without adding additional nutrients, as the liquid effluent comprising the humic substance may provide a sufficient benefit to the animals without the need for extra nutrients. As mentioned above, feeding animals crops that have been grown with humic substance may provide more benefits than if humic substances were directly ingested by the animals (e.g., see above with reference to dry matter to moisture ratio). Additionally, the presence of humic substance in the crops may decrease the level of carbon dioxide and/or methane produced by the animals, which can reduce greenhouse gas emissions.

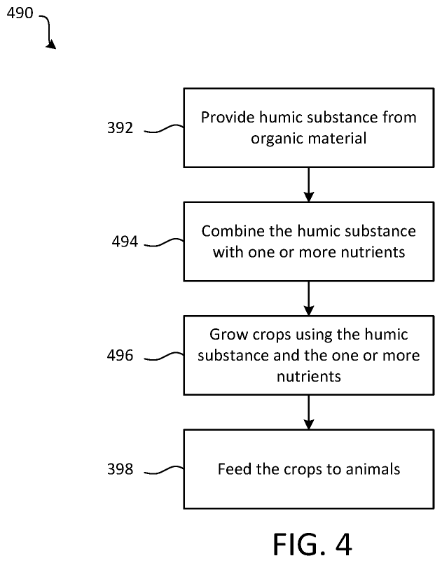

In various embodiments, and with reference to FIG. 4, the method 490 improving animal health may include, in addition to previously described steps 392 and 398, combining the humic substance with one or more nutrients at step 494. Step 494 may be performed after the humic substance has been obtained at step 392 via the system and method described above with reference to FIG. 1. Accordingly, the method 490 may include growing crops using not only the humic substance but also the nutrients at step 496. For example, the substantially neutral effluent containing the humic substance may be combined at step 494 with one or more nutrients, such as copper, magnesium, manganese, cobalt, zinc, phosphate, etc. These nutrients may provide various benefits to the animal that feeds on the crop, such as digestive benefits and/or immune system benefits.

In various embodiments, the crop grown at step 496 may be a sod, grass, fodder, or other plant, and the crop may be referred to herein as a nutrient crop if grown with both liquid effluent containing humic substance and one or more nutrients. The nutrient crop may be grown (step 496) in soil, or the crop may be grown in a soil-less environment. That is, the crop growth may be hydroponic or aeroponic. In various embodiments, the humic substance and the nutrients are combined and added to the crop in a static irrigation environment. For example, the crops may be grown via a holoponic technique that includes a static irrigation environment of humic substance with nutrients. That is, the nutrient crops may be grown in a mixture of the liquid effluent comprising the humic substance and the additional nutrients. This holoponic growing method does not include water egress but instead utilizes this mixture (of humic substance and nutrients) that does not actively flow over/across the roots but instead remains static/stagnant while still enabling rigorous crop growth. As mentioned above, the humic substance may facilitate chelation of the nutrients and nutrient uptake into the crop.

In addition to the general health benefits to the animals that feed on such crops, the improved health and digestive function of the animals has other benefits, such as reduced waste emission of carbon dioxide and other gases from the animals, reduced waste fiber (feces, manure) from the animals, and reduced irrigation requirements due to the aforementioned soil-less growing technologies that incorporate the humic substance.

The following experimental results are included herein to show concentration increases of various nutrients in wheat in response to growing the wheat with a combination of humic substance and the respective nutrient. A control group of wheat, grown without the combination of humic substance and nutrients, comprised 0.26 mass percent of magnesium, 54 parts per million (“ppm”) of zinc, 66 ppm of manganese, 1.7 ppm of copper, and 3 ppm of boron. Six test samples of wheat were grown and supplemented with a foliar application of humic substance and a respective nutrient in both static watering and hydroponic systems. The mass ratio of humic substance to the respective nutrient was between 100:1 and 200:1 for each of these test samples. The first test sample included zinc, and wheat grown with the combination of humic substance and zinc comprised 1600 ppm zinc (up from 54 ppm in the control). The second test sample included boron, and wheat grown with the combination of humic substance and boron comprised 530 ppm boron (up from 3 ppm in the control). The third test sample included manganese, and wheat grown with the combination of humic substance and manganese comprised 1700 ppm manganese (up from 66 ppm in the control). The fourth test sample included copper, and wheat grown with the combination of humic substance and copper comprised 1400 ppm copper (up from 1.7 ppm in the control). This level of copper is often considered toxic, and thus this amount of copper would not necessarily be implemented in animal feed, but the test still shows the significant increase in concentration of copper in crops grown with this method. The fifth test sample included magnesium, and wheat grown with the combination of humic substance and magnesium comprised 0.70% magnesium (up from 0.26% in the control). The sixth test sample included nitrogen, and wheat grown with the combination of humic substance and nitrogen comprised 3.4% nitrogen.

In actual implementation, multiple nutrients may be combined with the humic substance (instead of one at a time, as described in the preceding paragraph). For example, wheatgrass seed was grown under lab-controlled conditions using grow lamps. Multiple nutrients (e.g., sulfur, phosphorous, potassium, magnesium, calcium, sodium, iron, manganese, copper, and/or zinc) were combined with a humic substance and applied to the wheatgrass via foliar spray every 4-6 hours. The wheatgrass grew from seed to harvest in 7 days. The various dry weight mass concentrations of the various nutrients of the harvested wheatgrass were as follows: sulfur 0.24%, phosphorous 0.59%, potassium 0.61%, magnesium 0.22%, calcium 0.09%, sodium <0.01%, iron 62.7 ppm, manganese 67.0 ppm, copper 11.7 ppm, and zinc 70.4 ppm.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for improving nutrient density in crops, the method comprising:
providing a humic substance from an organic material;
combining the humic substance with at least one nutrient; and
growing the crops using a combination of the humic substance and the at least one nutrient.

2. The method of claim 1, further comprising feeding the crops to animals.

3. The method of claim 1, wherein the at least one nutrient comprises at least one of copper, magnesium, manganese, cobalt, zinc, and phosphate.

4. The method of claim 1, wherein combining the humic substance with the at least one nutrient is performed during growing the crops.

5. The method of claim 4, wherein combining the humic substance with the at least one nutrient comprises providing a static irrigation environment comprising the combination.

6. The method of claim 1, wherein growing the crops using the humic substance is performed in a soil-less environment.

7. The method of claim 6, wherein growing the crops is a hydroponic process.

8. The method of claim 6, wherein growing the crops is an aeroponic process.

9. The method of claim 1, wherein the organic material comprises a substrate within which mushrooms are grown.

10. The method of claim 9, wherein the substrate comprises at least one of wood chips and straw.

11. The method of claim 1, further comprising composting the organic material to convert it to organic compost material.

12. The method of claim 11, wherein composting the organic material to convert it to organic compost material comprises at least one of microbial composting and microbial metabolism of the organic material.

13. The method of claim 12, wherein the organic material comprises at least one of human biosludge, human waste, animal waste, animal carcasses, food, cellulosic materials, lignin, plant matter, wood chips, straw, peat, cardboard, paper, coffee grounds, coir, cocoa shell, garden waste, leaves, grass, seaweed, manure, mushrooms, tree bark, gypsum, hemp fibre, and eggshells.

14. The method of claim 13, wherein the organic material comprises about 90% cellulose.

15. The method of claim 1, wherein providing the humic substance comprises introducing a liquid to the organic material and collecting a liquid effluent, wherein the liquid effluent comprises the humic substance.

16. The method of claim 15, wherein introducing the liquid to the organic material comprises at least one heating step to facilitate extraction of the humic substance.

17. A method for improving animal health, the method comprising:
providing a humic substance from an organic material;
combining the humic substance with at least one nutrient;
growing crops using a combination of the humic substance and the at least one nutrient; and
feeding the crops to animals.

18. The method of claim 17, wherein combining the humic substance with the at least one nutrient is performed during growing the crops such that a combination of the humic substance and the at least one nutrient is provided to the crops during growth.

19. The method of claim 18, wherein growing the crops using the combination is performed in a soil-less environment.

20. A method for improving animal health, the method comprising:
providing a humic substance from an organic compost material;
combining the humic substance with at least one nutrient;
growing crops using a combination of the humic substance and the at least one nutrient in a soil-less environment; and
feeding the crops to animals.
